(19) United States
(12) Patent Application Publication
(10) Pub. No.: US 2021/0005909 A1
(43) Pub. Date: Jan. 7, 2021

(54) PORTABLE DEVICE FOR PRODUCING HYDROGEN, AND USE THEREOF

(71) Applicant: Apollon Solar, Saint-Priest (FR)

(72) Inventors: Oleksiy Nichiporuk, Mions (FR); Jed Kraiem, Bourgoin-Jallieu (FR)

(21) Appl. No.: 16/968,822

(22) PCT Filed: Feb. 13, 2019
(86) PCT No.: PCT/FR2019/050310

§ 371 Date: Aug. 10, 2020

(30) Foreign Application Priority Data
Feb. 13, 2018 (FR) 1851180

(51) Int. Cl. H01M 8/0606; C01B 3/08; C01B 3/50; H01M 8/0662; H01M 8/04007; H01M 8/04701

(52) U.S. Cl. CPC H01M 8/0606; C01B 3/08; C01B 3/503; H01M 2250/30; H01M 8/04067; H01M 8/04708; C01B 2203/041; H01M 8/0687

(57) ABSTRACT

Portable device (1) for producing hydrogen from a hydrogen precursor and a liquid, this device comprising—a main chamber (2), intended for receiving said hydrogen precursor and said liquid, —an additional chamber (6), intended for collecting the hydrogen thus produced, —a separation membrane (5), defining said main chamber relative to said additional chamber, —means (8) for discharging the hydrogen out of the additional chamber, and characterized in that it comprises heat exchange means (21), provided on at least one portion of the periphery of said main chamber. This device produces pure hydrogen which may supply a fuel cell.

### TECHNICAL FIELD OF THE INVENTION

The invention relates to the fields of chemistry and energy production, and more particularly the field of reactors used in chemical engineering for producing hydrogen. More precisely, the invention relates to a small hydrogen generator, capable of generating hydrogen by reaction between a chemical compound introduced in the solid state and an aqueous liquid. This hydrogen generator can be used to supply hydrogen to a portable fuel cell.

### PRIOR ART

Portable fuel cells can supply small electrical systems; such systems exist commercially. If they function on hydrogen, they need to be supplied with hydrogen by a hydrogen source, such as a hydrogen generator. It would be practical for this hydrogen generator also to be portable. Many portable hydrogen generators are known, generating hydrogen by electrolysis of water, described for example in GB 2 549 369 (O'Neill). However, it would also be practical for this portable hydrogen generator to function in a self-contained manner, autonomously, that is to say without needing an electrical energy supply. To have an autonomous hydrogen generator it is therefore necessary to generate hydrogen not electrochemically but chemically, usually by decomposing a solid hydrogen precursor in a liquid. U.S. Pat. No. 9,705,145 (Intelligent Energy Inc.) describes a hydrogen generator using thermal decomposition of a suitable compound such as AlH₃ or other hydrides; this system requires an integrated electric heating system. Systems are also known that decompose a metal hydride in an aqueous phase; in this case the reaction is controlled by the quantity of catalyst.

WO 2010/035250 (Societe BIC) describes a hydrogen generator using a solid compound capable of releasing gaseous hydrogen in a liquid medium; this solid compound is a borohydride, such as NaBH₄. This system comprises a reaction chamber, wherein said solid compound is put in contact with water and a catalyst based on noble metals that are expensive (ruthenium) or dangerous (cobalt), in order to decompose into a borate and gaseous hydrogen. The latter is discharged through a hydrophobic membrane, impermeable for water but permeable for hydrogen. The drawback of this generator is that the borate solution that results therefrom is toxic and must not be discharged into the waste-water pipework. Other hydrogen generators based on the decomposition of NaBH₄ in water are described in U.S. Pat. No. 3,459,510 (Union Carbide), U.S. Pat. No. 6,939,529 (Millennium Cell, Inc.), US 2005/0158595 (Integrated Fuel Cell Technologies), US 2007/0036711 (Ardica Technologies Inc.), WO 2010/075410 (BIC).

In general terms the prior art teaches that one of the problems posed by autonomous hydrogen generators is controlling the reaction conditions, since the kinetics of the chemical reactions able to generate hydrogen, whether they be endothermic or exothermic, depends greatly on the temperature of the reaction medium. Another problem is that it is not desirable for the generator to use products that are dangerous, toxic and/or difficult to store and/or to manipulate as a compound capable of releasing hydrogen. It is also not desirable for the hydrogen generator to generate toxic byproducts or more generally products (such as an aqueous or solid phase) that require particular attention for being discharged. And finally it is desirable for the gaseous hydrogen that is produced by the portable generator to be as pure as possible, in order not to degrade the functioning of the fuel cell that it supplies.

In view of the above, the invention aims to remedy at least some of the drawbacks of the prior art.

The invention aims in particular to propose a device which, while being small and of low mass, ensures reliable production of hydrogen.

The invention also aims to propose such a device that provides effective separation between the initial products of the reaction and the hydrogen thus produced.

The invention also aims to propose such a device that makes it possible to regulate the temperature prevailing in the reaction zone.

The invention also aims to propose such a device the structure of which is simple and the use of which is intuitive for the operator.

### OBJECTS OF THE INVENTION

To this end an object of the invention is a portable device for producing hydrogen from a hydrogen precursor and a liquid, this device comprising
a main enclosure, intended for receiving said hydrogen precursor and said liquid,
heat exchange means, provided on at least part of the periphery of said main enclosure,
an additional chamber, intended to collect hydrogen thus produced,
a separation membrane delimiting said main enclosure with respect to said additional chamber,
means for discharging the hydrogen out of the additional chamber.

Said hydrogen precursor may be a solid precursor, for example a powder of a suitable metal; the pH of the liquid phase is adjusted according to the metal.

According to other features of the device according to the invention, the device may comprise:
active cooling means (such as ventilation means) that cooperate with the heat exchange means,
means for measuring the temperature at the wall of the main enclosure,
slaving means, for slaving the active cooling means (in particular the ventilation means) to the temperature measurement means.

According to yet other features of the device according to the invention:
this device further comprises means for removably fixing the additional chamber with respect to the main enclosure,
the removable fixing means comprise a quick coupling, in particular of the quarter-turn type,
the hydrogen discharge means comprise a quick coupling, able to be connected to a pipe supplying a fuel cell,
the hydrogen discharge means comprise a safety valve calibrated to a predetermined pressure,
the ventilation means comprise an electric fan that is supplied by power supply means able to be connected to a fuel cell,
the bottom of the additional chamber, turned towards the main enclosure, comprises a lattice against which the separation membrane is pressed, this lattice defining openings for the hydrogen to pass,
the heat exchange means comprise a plurality of fins extending outwards (preferably radially), from the periphery of the main enclosure,
this device further comprises a sheath confining the ventilation air, extending at the periphery of the heat exchange means,
an additional chamber comprises means for trapping the residual moisture present in the hydrogen,
the separation membrane is permeable to gaseous hydrogen while being impermeable to polar liquids,
the separation membrane is produced from metallic or non-metallic material, and in the latter case preferably from ceramic material or polymer material;
the largest dimension of the device is less than 800 mm, in particular less than 250 mm,
the total mass of the device, empty, is less than 5.0 kg, and in particular less than 1.0 kg.

Another object of the invention is a use of the above device for supplying a fuel cell.

### DESCRIPTION OF THE FIGURES

FIGS. 1 to 13 illustrate an embodiment of the invention, but do not limit the scope of the invention.

FIG. 1 is a view in longitudinal section of a portable hydrogen production device according to the invention that is associated with a fuel cell.

FIGS. 2 and 3 are perspective views illustrating, at two different angles, the portable hydrogen production device according to the invention.

FIGS. 4 to 6 are views respectively in perspective, front view with partial cutaways and end view, illustrating the main enclosure of the device according to the invention, as well as fins provided at the periphery of this enclosure.

FIGS. 7 to 9 are views respectively in perspective, front view and end view, illustrating the additional chamber of the device according to the invention.

FIGS. 10 and 11 are views respectively in longitudinal section and in perspective, illustrating a plug closing the additional chamber of the device according to the invention.

FIGS. 12 and 13 are views respectively in longitudinal section and in perspective, illustrating a plug closing the main enclosure of the device according to the invention.

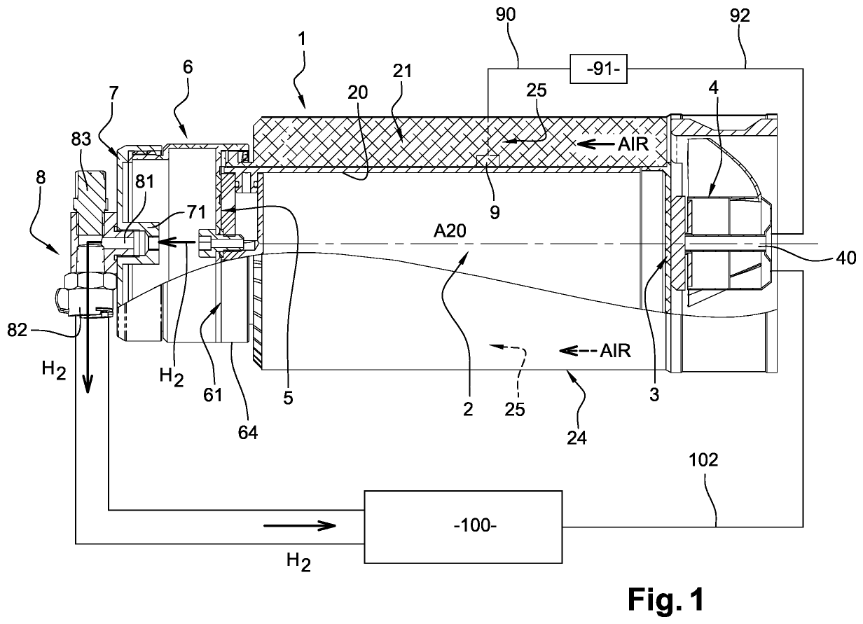

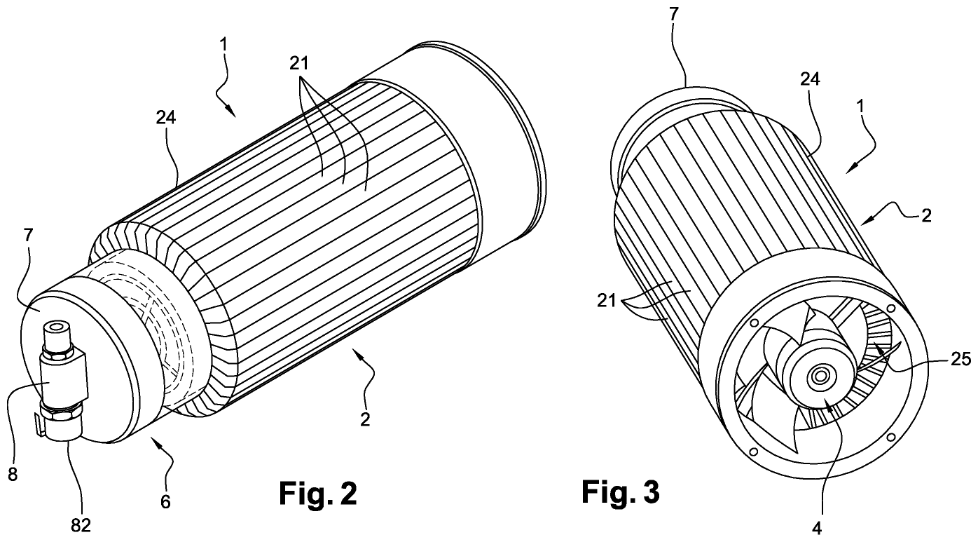

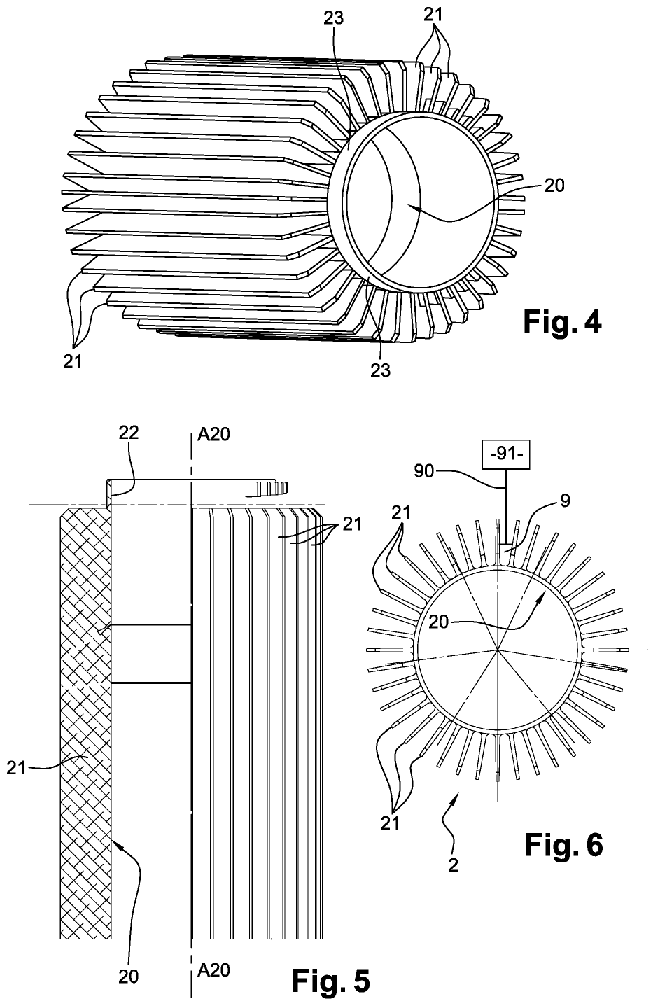

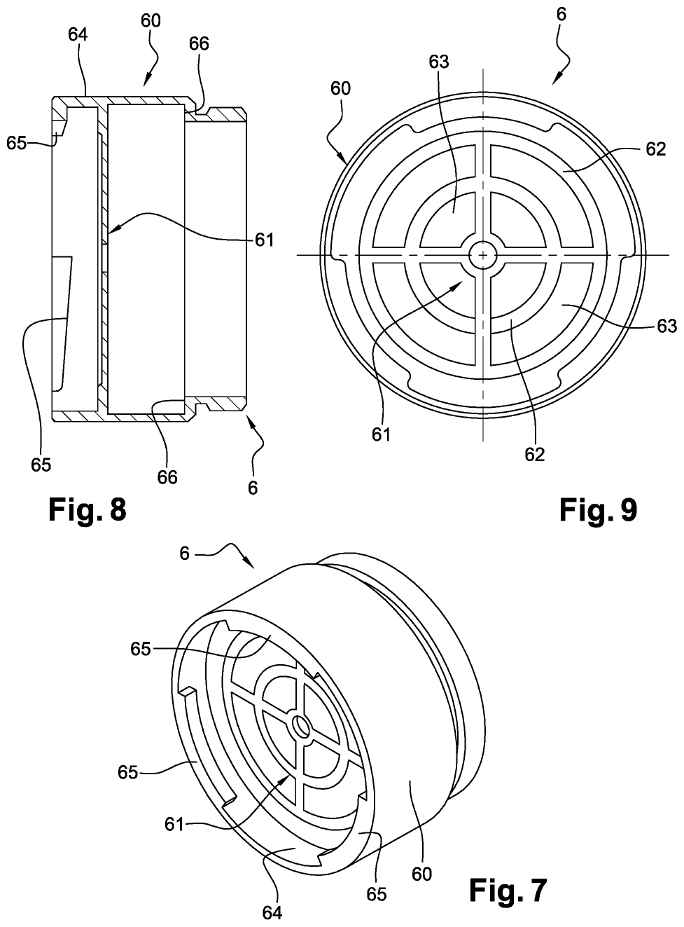

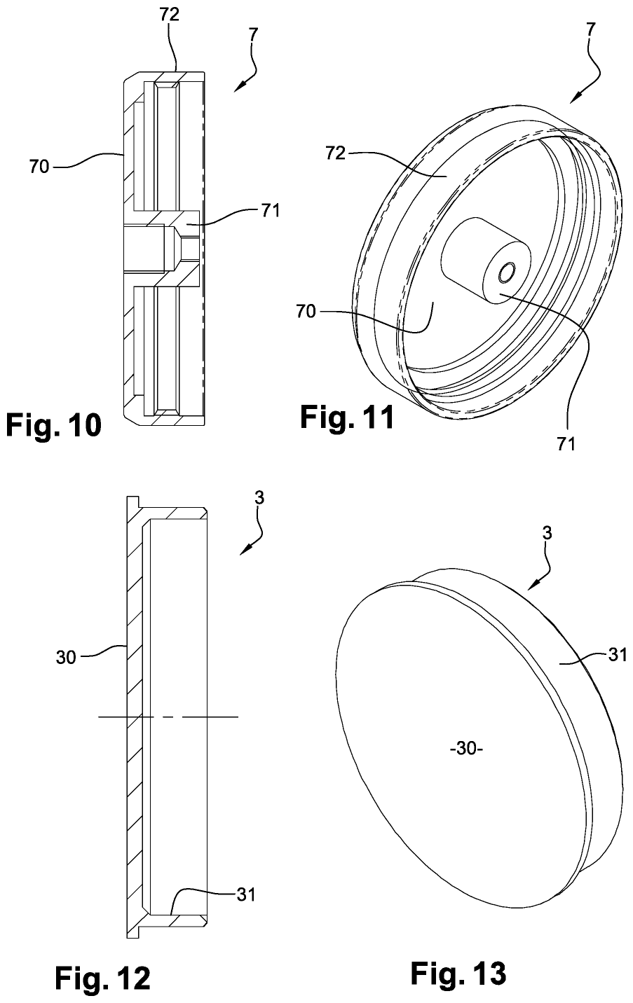

The following numerical references are used on the figures and in the description:

| | |
|---|---|
| 1 | Device according to the invention |
| 2 | Main enclosure |
| 3 | Plug |
| 4 | Fan |
| 5 | Hydrophobic membrane |
| 6 | Auxiliary chamber |
| 7 | Plug |
| 8 | Hydrogen discharge member |
| 9 | Temperature sensor |
| 20 | Main barrel |
| 21 | Fins |
| 22 | Neck |
| 23 | Recess |
| 24 | Sheath |
| 25 | Air confinement path |
| 30 | Cover |
| 31 | Rim |
| 40 | Screw |
| 60 | Cylindrical cartridge |
| 61 | Bottom |
| 62 | Band |
| 63 | Intermediate passage |
| 64 | Neck |
| 65 | Rib |
| 66 | Shoulder |
| 70 | Cover |
| 71 | End piece |
| 72 | Rim |
| 80 | Stud |
| 81 | Channel |
| 82 | Coupling |
| 83 | Safety valve |
| 90 | Electrical line (signal) |
| 91 | Monitoring/control module |
| 92 | Electrical line (signal) |
| 100 | Fuel cell |
| 104 | Pipe |
| A20 | Longitudinal axis of 20 |

### DETAILED DESCRIPTION

The accompanying figures describe a hydrogen production device according to the invention that is of the portable type. Within the meaning of the invention, the term “portable” signifies that this device can be transported and handled by an operator without any great physical effort. To this end, the largest dimension of the device is advantageously less than 330 mm, in particular less than 280 mm. Moreover, the weight empty thereof is advantageously less than 1200 g, in particular less than 1000 g.

This device, designated overall by the reference 1, comprises first of all a main enclosure 2 intended for receiving a solid hydrogen precursor and a liquid so as to form hydrogen.

This enclosure comprises a main barrel 20 that is typically cylindrical, the longitudinal axis of which is denoted A20, which corresponds to the principal axis of the device. A plurality of fins 21, extending longitudinally, are fixed by any suitable means to the external periphery of the barrel. By way of example, fixing by welding or brazing is preferred, if the cylindrical main barrel 20 and the fins 21 are manufactured from metal, for example extruded aluminum alloy.

It should be noted that the main enclosure 2 and the main barrel 20 may have a shape other than cylindrical, such as: oval, prismatic or otherwise flattened, with heat exchange means (in particular fins 21) that may cover the whole or only part of the periphery of the main enclosure 2.

At its first end, the internal volume of the barrel 20 is closed off by a plug 3. The latter comprises a closed cover 30, extending axially by a rim 31. The diameter of the plug is close to that of the barrel, but less than that of the fins. Consequently, as will be seen hereinafter, this plug does not prevent the progression of air in the vicinity of these fins.

This plug 3 supports a fan 4, of any suitable type, in particular electric. This fixing is advantageously of the removable type, for example by means of a screw 40. The fan 4 is supplied by a cable 102, depicted schematically, which is connected to a fuel cell 100, also illustrated schematically. In other words, the electrical energy generated by the fuel cell is able to supply the fan 4. The energy consumption of this fan 4 is low, for example 2 W, which corresponds at most to a few percentages of the electrical energy generated by the fuel cell.

The second end of the valve 20, opposite to the plug 3, comprises an end neck 22 hollowed out by means of recesses 23, the function of which will be described below. This second end is closed off by a hydrophobic membrane 5 that is permeable to gases while being impermeable to polar liquids. In other words, this membrane allows the hydrogen produced to pass, while preventing flow of the polar liquid.

Preferably this membrane 5 is produced from any material suitable for the above function. In this regard, it may be produced from a ceramic, polymer or metal material permeable to hydrogen. Since sheets of metal materials permeable to hydrogen (especially palladium) are very expensive, a non-metallic material is preferred. Thus membranes made from polymer material are preferred. According to advantageous embodiments, the membrane is produced in particular from PTFE (polytetrafluoroethylene), PVDF (polyvinylidene fluoride), polyethylene or polypropylene; advantageously it has pores with a size of between approximately 0.1 μm up to approximately 0.5 μm.

The membrane 5 described above separates the main enclosure vis-à-vis a so-called additional or auxiliary chamber 6. This chamber 6 comprises a cylindrical cartridge 60, the first end of which, turned towards the enclosure 2, is closed by means of a bottom 61. The latter is produced in the form of a lattice, or strainer cloth, which is composed of bands of concentric material 62, which delimit intermediate passages 63. This lattice 61 provides reliable holding of the membrane by pressing, while the passages 63 allow flow of the hydrogen from the enclosure 2 to the chamber.

This bottom 61 is extended by a neck 64, which is provided with ribs 65 intended to cooperate with the aforementioned recesses 23. This cooperation provides removable fixing, of the quarter-turn quick coupling type, between the main enclosure 2 and the additional chamber 6. This chamber 6 is furthermore equipped with means for trapping any residual moisture present in the hydrogen flowing in this chamber. For this purpose, the chamber 6 has in particular shapes providing changes in the cross section thereof, by means of a shoulder 66. It is possible to provide any other type of shape, fulfilling this trapping function, for example baffles or the like.

Opposite the enclosure 2, the additional chamber 6 is closed by means of a plug 7. The latter comprises first of all a cover 70, which is provided with a so-called tapping end piece 71, allowing discharge of the hydrogen out of the chamber 6. The cover 70 is extended axially by a threaded rib 72, enabling the plug to be screwed onto a threaded portion of the cartridge 60.

The plug 7 cooperates with a member providing discharge of the hydrogen in the direction of the fuel cell 100, which is designated overall by the reference 8. This discharge member comprises a stud 80, allowing fixing on the plug 7 by any suitable means. This stud is hollowed out by a channel 81, which emerges in a coupling 82, of a type known per se. This coupling 82 is able to be connected removably to a pipe 104 put in communication with the inlet of the fuel cell 100. Moreover, the discharge member 8 is equipped with a safety valve 83, which is calibrated to a predetermined pressure, typically around 0.5 bar.

The device 1 of the invention is furthermore equipped with a temperature sensor 9, of any suitable type. This sensor 9 is fixed in the vicinity of the barrel 20, between two adjoining fins 21, so that it makes it possible to measure the temperature prevailing inside the main enclosure 2. This sensor is connected, via a line 90 to a monitoring/control module 91 of a type known per se, which is itself connected to the fan 4 via a supplementary line 92. This monitoring/control module 91 may be integrated in the device 1 or may be situated outside, for example in a module comprising the fuel cell 100 supplied by the device. Said monitoring/control module 91 may advantageously use an algorithm of the PID (proportional, integral, derivative) type, which is known per se.

Finally, the device according to the invention advantageously comprises a sheath 24, extending at the external periphery of the fins. This sheath is produced from a material known per se, in particular of the thermoshrinking plastic type. The facing walls of this sheath and of the barrel 20 delimit a path 25 for confinement of the air, in the vicinity of the fins 21. This improves the efficacy of the cooling by the forced air flow generated by the fan 4 between the fins 21 and the sheath 24. Moreover, the presence of this sheath 24 is advantageous in terms of safety, since it allows risk-free gripping by the user, protecting the user firstly against the edges of the fins 21 and secondly against heat.

Use of the device according to the invention described above will now be explained. The internal volume of the main enclosure 2 is accessed by releasing the cartridge 60 with respect to the barrel 20. Then, in this enclosure, the hydrogen precursor and the polar liquid intended to produce the required hydrogen are placed. Then the cartridge is once again locked on the barrel.

In particular, the hydrogen precursor may be a solid precursor, for example a metal, which is introduced advantageously in suitable finely divided form. Preferably it is a metallic powder, which must be chosen so as to avoid the formation of toxic secondary products. It may comprise a suitable catalyst. This metallic powder may be contained in a tablet or in a flexible package permeable to the appropriate polar liquid to avoid dispersion thereof. Said polar liquid may be water, the pH of which is adjusted according to the metal. It is possible to use a powder based on aluminum, silicon, magnesium or other metal.

It should be noted that the reaction of generating hydrogen from a metal, such as aluminum or silicon, is significantly more exothermic than the reaction of generating hydrogen from NaBH₄. This requires providing means for dissipating the reaction heat if it is wished to exploit the reaction under controlled conditions.

At the end of a start-up period, for example a few tens of seconds, the hydrogen production is initiated. This hydrogen enters through the membrane 5, whereas the latter retains the liquid inside the main enclosure 2. This hydrogen next passes through the additional chamber 6, being freed of its residual moisture, and is then directed in the direction of the fuel cell 100 by means of the discharge member 8. The reaction of the metallic powder with said polar liquid being highly exothermic, the temperature of the liquid increases quickly, which accelerates said reaction. The increase in temperature is limited by the effect of the heat exchange means provided on at least part of the periphery of the main enclosure; these heat exchange means may be said fins 21.

In an advantageous embodiment, the temperature is monitored and regulated. For this purpose, in parallel, the sensor 9 measures the temperature prevailing inside the main enclosure or at the surface of the enclosure. According to the data from this sensor, the module 91 controls the speed of the fan 4, so as to regulate the aforementioned temperature around a predetermined set value, typically between 40° C. and 70° C., and preferentially between 50° C. and 65° C., and even more preferentially between 60° C. and 65° C. The system is regulated so that the temperature advantageously does not exceed 70° C., and preferentially does not exceed 65° C., in order to avoid the user of the device burning himself when he touches it. The inventors have found that this device can function in a wide range of external temperatures, and particularly between 0° C. and 45° C.

The hydrogen production reaction continues continuously, during a period typically around an hour. At the end of this reaction, the cartridge is released once again, so as to access the internal volume of the enclosure. It is thus possible, where applicable, to extract the package that contained the solid hydrogen precursor powder and replace it with a new package, or place a new tablet containing the powder of said solid hydrogen precursor, and/or it is possible to replace the polar liquid that contains the soluble byproducts of the reaction, in order to restart the hydrogen generation.

The invention has numerous advantages

Thus it provides reliable separation between the hydrogen produced and the liquid, by means of the presence of the membrane 5. It should be noted that this membrane allows functioning of the device in all spatial configurations, in particular vertical or horizontal.

Moreover, the additional chamber 6 advantageously fulfils a triple function. First of all, it provides the closure of the main enclosure. Moreover, it forms a phase separator, trapping the residual moisture contained in the hydrogen generated, whether in the form of droplets or in the form of water vapor. This improves the purity of the hydrogen at the outlet of the discharge member 8; for this reason the hydrogen generator according to the invention is particularly suitable for supplying a fuel cell. Finally, the additional chamber 6 integrates a supplementary safety function, by virtue of the advantageous presence of the valve 83.

Advantageously, the fan 4 aspirates air through the fins 21. Such a configuration has improved efficacy, compared with blowing into these fins.

The invention also allows effective regulation of the hydrogen production device, in a thermal sense. This is because the presence of the measuring and control means make it possible to operate the fan at the desired power, so as to regulate the temperature inside the enclosure at the required value. Thus the reaction takes place under constant temperature conditions, apart from the start-up phase at ambient temperature, which allows a constant production of hydrogen.

Finally, the device according to the invention is compact and portable, and particularly convenient to handle. In this regard, the presence of the removable locking means is particularly advantageous. The operator can thus, quickly and intuitively, lock and unlock the additional chamber vis-à-vis the main enclosure. The interior of the device is easy to clean.

Thus an apparatus has been produced from aluminum alloy with an approximate size of 90 mm×240 mm, with an internal volume of 360 cm³. The generator weighs empty approximately 800 g and has around thirty fins with a thickness of 1.5 mm and a size of approximately 16 mm×160 mm. It is possible to load it with approximately 45 g of metallic powder and approximately 200 ml of water, and it then produces, over a period of 80 minutes, approximately 45 liters of hydrogen, with a constant output (after a start-up phase) of around 0.5 liters per minute. The maximum power of the fan is 2.2 W with a maximum rotation speed of 5000 revolutions per minute, a maximum output of 1.3 m³ of air per minute and a static air pressure of 156 Pa.

1. A portable device for producing hydrogen from a hydrogen precursor and a liquid, the portable device comprising:
a main enclosure, intended for receiving said hydrogen precursor and said liquid,
an additional chamber, intended to collect hydrogen thus produced,
a separation membrane, delimiting said main enclosure with respect to said additional chamber,
means for discharging the hydrogen, out of the additional chamber, and characterized in that it comprises heat exchange means, provided on at least part of the periphery of said main enclosure.

2. The portable device according to claim 1, characterized in that it comprises at least one active cooling means that cooperates with said heat exchange means.

3. The portable device according to claim 2, characterized in that it comprises ventilation means that cooperate with the heat exchange means.

4. The portable device according to claim 3, characterized in that it comprises means for measuring the temperature at a wall of the main enclosure.

5. The portable device according to claim 4, characterized in that it comprises slaving means, for slaving the active cooling means to the temperature measurement means.

6. The portable device according to claim 5, characterized in that this device further comprises means for removably fixing the additional chamber with respect to the main enclosure.

7. The portable device according to claim 6, characterized in that the removable fixing means comprise a quick coupling, in particular of the quarter-turn type.

8. The portable device according to claim 7, characterized in that the hydrogen discharge means comprise a quick coupling able to be connected to a pipe supplying a fuel cell.

9. The portable device according to claim 8, characterized in that the hydrogen discharge means comprise a safety valve calibrated to a predetermined pressure.

10. The portable device according to claim 9, characterized in that the ventilation means comprise an electric fan that is supplied by power supply means able to be connected to a fuel cell.

11. The portable device according to claim 10, characterized in that a bottom of the additional chamber, turned towards the main enclosure, comprises a lattice against which the separation membrane is pressed, this lattice defining openings for the hydrogen to pass.

12. The portable device according to claim 11, characterized in that the heat exchange means comprise a plurality of fins extending outwards from the periphery of the main enclosure.

13. The portable device according to claim 12, characterized in that the portable device further comprises a sheath for confining the ventilation air, extending at the periphery of the heat exchange means.

14. The portable device according to claim 13, characterized in that the additional chamber comprises means for trapping the residual moisture present in the hydrogen.

15. The portable device according to claim 14, characterized in that the separation member is permeable to gases while being impermeable to liquids.

16. The portable device according to claim 15, characterized in that said separation membrane is produced from polytetrafluoroethylene, polyvinylidene fluoride, 25 polyethylene or polypropylene.

17. A method for supplying a fuel cell comprising providing and using the portable device of claim 5.

18. The method according to claim 17, wherein said slaving means are at least partly contained in a module comprising a fuel cell.
